(19) United States
(12) Patent Application Publication
(10) Pub. No.: US 2026/0349815 A1
(43) Pub. Date: Nov. 5, 2026

(54) DYNAMIC EMBEDDING PROCESS BASED ON SYSTEM RESOURCE UTILIZATION

(71) Applicant: HEWLETT PACKARD ENTERPRISE DEVELOPMENT LP, Spring, TX (US)

(72) Inventors: Annmary Justine Koomthanam, Fort Collins, CO (US); Suparna Bhattacharya, Bangalore (IN); Martin Foltin, Fort Collins, CO (US); Paolo Faraboschi, Sant Cugat, CA (US)

(21) Appl. No.: 19/246,926

(22) Filed: Jun. 24, 2025

(30) Foreign Application Priority Data
Apr. 30, 2025 (IN) 202541041731

(51) Int. Cl. G06F 9/50

(52) U.S. Cl. CPC G06F 9/5027

(57) ABSTRACT

Systems and methods are provided for managing a dynamic embedding process based on current system resource utilization. In this way, the system resource utilization value may correspond to memory utilization, CPU or GPU consumption, or other use of a system component and the disclosed technology can adjust the embedding process based on these values.

### BACKGROUND

In computational searching, an “embedding” refers to a technique where text or other data is converted into a mathematical representation that captures the semantic meaning of the converted data. A search engine is able to conduct a search more efficiently using embeddings. In this sense, relevant results of the search are based on the underlying or semantic meaning of the search rather than just matching keywords to generate search results, thus enabling more accurate searching capabilities of the system.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 illustrates a set of computing components in a distributed system, including an object client, data intelligence engine, workload computing component, and search component, in accordance with some examples of the disclosed technology.

FIG. 2 illustrates a data intelligence engine comprising a data path component, an embedding computing component, a workload optimizer engine, and a vector data store in which examples of the disclosed technology may be implemented.

FIG. 3 is an example message flow between the data path component and the embedding computing component, in accordance with some examples of the disclosed technology.

FIG. 4 illustrates an embedding profile data structure, in accordance with some examples of the disclosed technology.

FIG. 5 is an example message flow between the workload optimizer engine, processor of the embedding computing component, and the vector data store, in accordance with some examples of the disclosed technology.

FIG. 6 is an example message flow between the search component, processor of the embedding computing component, and the vector data store, in accordance with some examples of the disclosed technology.

FIG. 7 is an example message flow between the data path component and the embedding computing component, in accordance with some examples of the disclosed technology.

FIG. 8 is an example method for implementing a dynamic embedding process based on system resource utilization, in accordance with examples of the disclosed technology.

FIG. 9 is a computing component that may be used to implement dynamic embedding process based on system resource utilization, in accordance with examples of the disclosed technology.

FIG. 10 depicts a block diagram of an example computer system in which various examples of the disclosed technology described herein may be implemented.

The figures are not exhaustive and do not limit the present disclosure to the precise form disclosed.

### DETAILED DESCRIPTION

Traditional systems can generate embeddings of data objects to expedite and efficiently search for the data later on. However, the process for generating the embeddings can be computationally expensive. Additionally, near real-time embedding generation for latency-sensitive storage systems can impact the quality of service of the input/output (I/O), processor, and subsystems. For example, the embedding process in traditional systems can use unlimited resources when a data object is identified to generate the embedding.

In some examples, the embedding process (and use of the resulting embedding) is implemented through a distributed system. For example, the distributed system may comprise a data intelligence engine in communication with an object client, a workload computing component, and a search component. The object client may generate/store data in an object storage system (e.g., in buckets/collections of data) and provide the data or data object to the data intelligence engine. The data intelligence engine may initiate an embedding process to generate an embedding of the received data object. In some examples, the embedding process is implemented using a third party entity, referred to as a workload computing component, that offers service-based or function-based resources to help expedite the embedding process (which may be heavily resource intensive). The workload computing component may be separate from the data intelligence engine and the object client. The data intelligence engine may call the service/function provided by the workload computing component to help generate the embedding during the embedding process.

Examples of the disclosed technology comprise systems, methods, and computer readable media that can manage a dynamic embedding process implemented in a distributed system based on current system resource utilization measured by the workload computing component. Current system resource utilization may correspond to, e.g., memory utilization, Central Processing Unit (CPU) or Graphics Processing Unit (GPU) consumption, I/O throughput, or other operation of system measured by the workload computing component that can be utilized by a service/function call from the data intelligence engine. By considering what resources the data path component, the workload computing component, and other system components are currently utilizing, as computed by the workload computing component, the data intelligence engine can adapt the embedding process. The embedding process can be adapted so as not to degrade compute or memory performance of the workload computing component as it processes services/functions from the data intelligence engine along with other services/functions across the distributed system. The workload computing component may calculate/measure system utilization while the resource consumption is coming from the data path component and the embedding component. That is, if system resources are currently being stressed by the data path component or the embedding component, examples of the disclosed technology may employ an embedding process that minimizes/limits any further impact to those system resources. On the other hand, if system resources are currently idle or are otherwise being used lightly, examples of the disclosed technology may employ a more resource-intensive embedding process and utilize more of the system resources provided by the workload computing component.

In some examples, the data intelligence engine may select an embedding profile from a set of embedding profiles according to which artificial intelligence (AI) model can generate an embedding of a data object. Individual ones of the set of embedding profiles may generate an embedding at different accuracy levels. For example, a first embedding profile (e.g., an approximate embedding profile) may be associated with a first AI model that generates an “approximate embedding” of a data object, and a second embedding profile (e.g., an accurate embedding profile) may be associated with a second AI model that generates an “accurate embedding” of the data object. When comparing the two embeddings, the approximate embedding may use fewer system resources to generate the embedding than the accurate embedding process, which can create an embedding that is smaller in size, having a lower accuracy level than the accurate embedding. The use of fewer system resources can allow the workload computing component and the data intelligence engine to perform other operations, for example, I/O procedures, memory utilization, and processing functions, while still creating an embedding, without waiting for the resources to become available for creating the embedding. Overall, the workload computing component and the data intelligence engine can create the approximate embedding while also leaving enough headroom for other tasks to take advantage of the available resources to perform their operations, thereby increasing the efficiency of the overall system.

In some examples, the approximate embedding and accurate embedding are two points in a spectrum of creating vector representations of data, allowing the selection of one embedding process to tradeoff between accuracy and efficiency with respect to the second embedding process. “Accurate” embeddings may correspond to high fidelity in representing the original data and involve more complex computation and higher dimensions than approximate embeddings. “Approximate” embeddings may correspond to a low-dimensional encoding that prioritizes efficiency, speed, and scalability over the complex computations used in the accurate embedding process.

In some examples, the approximate embedding profile may be dynamically selected when a current system resource utilization value of the workload computing component exceeds a resource utilization threshold, so that the embedding process executed in accordance with the approximate embedding profile does not interfere and limit the use of other system resources while the system resources are executing instructions unrelated to the embedding process. When the current system resource utilization value falls below the resource utilization threshold, the processor of the data intelligence engine may switch to a second embedding process/profile to generate a more accurate embedding. This may correspond to a two-pass embedding approach, where the first pass is to generate the approximate embedding (e.g., using a low CPU/GPU utilization and high throughput) and the second pass is to generate the accurate embedding (e.g., using a high CPU/GPU utilization and low throughput). Generating embeddings in accordance with the accurate embedding profile may generate an embedding with a larger file size than that generated in accordance with the approximate embedding profile, using system resources that were previously unavailable or limited for generating the embedding.

The data intelligence engine can dynamically switch between two embedding profiles, for example, based on the resource utilization or resource availability of the workload computing component. In some examples, the data intelligence engine may include a workload optimizer engine to initiate the switching between the two embedding profiles and a processor to execute the embedding process. For example, the workload optimizer engine can identify which embedding profile to use in generating the embedding of the data object. When an embedding profile is assigned to a processor of the data intelligence engine, internal resources may also be assigned to execute the embedding process. The embedding process may utilize a maximum of an in-memory queue limit, concurrent processing task limit, memory buffers, processors (e.g., CPU cores or GPUs), or other system components based on the applied embedding profile.

Upon creation of an embedding, a search component can utilize the embedding (e.g., to generate a response to the search with the corresponding data object). The search component, which can include, but is not limited to a Retrieval-Augmented Generation (RAG), Large Language Model (LLM), semantic search component, or other search component, may use either the accurate embedding or the approximate embedding, as described herein.

Technical improvements are described throughout the disclosure. For example, the data intelligence engine can generate quick and efficient embeddings without significantly interfering with other processing, based on a status of the system's workloads (e.g., at the workload computing component). When the workloads are idle or the system is less impacted, the embeddings can be rerun or more accurate embeddings can be generated than before. These later generated embeddings can be more accurate and use more of the available processing power of the system.

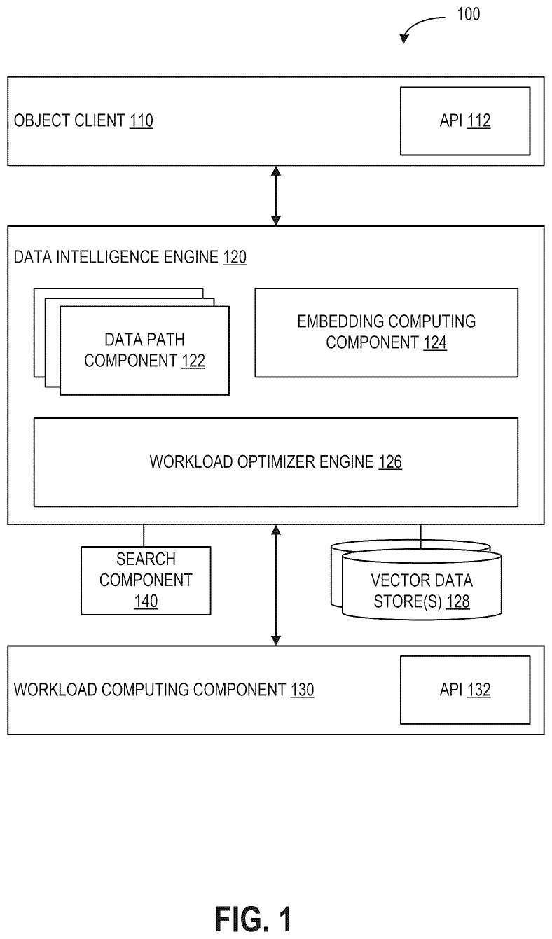

FIG. 1 illustrates a set of computing components 100 in a distributed system, including an object client 110 (e.g., data provider), data intelligence engine 120 (e.g., embedding provider), workload computing component 130 (e.g., workload service provider), and search component 140 (e.g., search provider), in accordance with some examples of the disclosed technology. In this example, search component 140 may use or implement, for example, chatbots, RAG, LLM, Generative Artificial Intelligence (GenAI), semantic clustering, or other applications that search for data/objects. These distributed components may be implemented via one or more machines, without diverting from the essence of the disclosure.

Object client 110 may be configured to provide data associated with the embedding process to data intelligence engine 120. For example, object client 110 may upload data from an object store to data intelligence engine 120 (e.g., via a data path). The uploading process may be implemented using “PUT” calls and the downloading process may be implemented using “GET” calls.

The data from object client 110 may be transmitted via application programming interface (API) 112 to data intelligence engine 120. API 112 may collate data from object client 110, format it for export, and transmit it to data intelligence engine 120.

Object client 110 may also be configured to provide data associated with an embedding to search component 140. For example, search component 140 may access the embedding (e.g., during the searching process for data that is used to generate a response to a query/prompt). The embedding may correspond to a data object stored at object client 110. Object client 110 may retrieve the data and provide it to search component 140 or, in some examples, may provide the data in response to receiving a request from search component 140 for the data corresponding to the embedding.

Data intelligence engine 120 may be configured to receive data from object client 110 (e.g., via data path component 122) and convert/store it as a data object. The data object may comprise structured or unstructured information (e.g., text, image, audio, video, etc.). Data intelligence engine 120 may also comprise data path component 122, embedding computing component 124, and workload optimizer engine 126. Data path component 122 is configured to receive data and identify its communication path or originating location. In some examples, data path component 122 can expose protocol endpoints, like Amazon® s3 and Network File System (NFS), to receive data. Data path component 122 can receive the data through protocol APIs, such as OBJECT PUT or FILESYSTEM WRITE.

Embedding computing component 124 may be configured to generate the embedding using the embedding profile set at that point of time. If the embedding profile is set as an approximate embedding, the data object is added to a delay processing queue maintained by the processor. The embeddings can be stored in vector data store 128 in the appropriate collection associated with the bucket or namespace. The approximate and accurate embeddings can be stored in separate collections.

Embedding computing component 124 may also be configured to determine a system resource utilization value of a system resource using a system resource utilization calculation. In some examples, the system resource is located at workload computing component 130, which may be located remotely from data intelligence engine 120 and object client 110. The system resource utilization value may identify an amount of a system resource that is utilized by data intelligence engine 120, while workload computing component 130 remotely provides a service/function. The system resource utilization value may include an amount of memory that is utilized, the CPU or GPU consumption value, or utilization value for other resources in workload computing component 130. Multiple utilization values may be determined, including a first and a second system resource utilization value.

In some examples, the system resource utilization value is calculated remotely from data intelligence engine 120 and object client 110. The calculation may be executed by workload computing component 130, which may be remote from data intelligence engine 120 and object client 110. In other examples, workload computing component 130 may be incorporated with data intelligence engine 120 and the calculation by workload computing component 130 is executed within data intelligence engine 120 (e.g., as a separate component from workload optimizer engine 126).

The system resource utilization value may be determined in association with a particular component of workload computing component 130 and an amount with which the component is being utilized (e.g., throughput, storage used/remaining). For example, embedding computing component 124 can identify the resources that are utilized by data path component 122 in executing a service or other action. The embedding computing component 124 and data path component 122 may be two components that can compete for system resources within the data intelligence engine 120. In this sense, the resource utilization by the embedding computing component 124 may be throttled/adjusted so that it may not consume more and degrade the quality of the service provided by data path component 122. The functionality provided by workload computing component 130 can be accessed by data intelligence engine 120 via API 132 of workload computing component 130.

In some examples, components of data intelligence engine 120 (e.g., data path component 122, embedding computing component 124, or workload optimizer engine 126) may execute various processes that can be calculated as the current system resource utilization. When the current system resource utilization exceeds the resource utilization threshold, data intelligence engine 120 (as a whole or the components therein) may not be able to properly execute the processes. In this instance, workload computing component 130 may remotely calculate the workload of these components to determine whether the current system resource utilization is exceeding the resource utilization threshold or performing below/within it.

Embedding computing component 124 may also be configured to dynamically switch between embedding profiles in association with the system resource utilization value. For example, based on the resource utilization or resource availability of the workload computing component 130, embedding computing component 124 may select a first embedding profile to use in generating the embedding of the data object. When an embedding profile is applied, data intelligence engine 120 can assign its internal resources to the embedding process and initiate the embedding process in view of the current embedding profile. Resources may include memory queues/buffers, concurrent processing functionality, processors (e.g., CPU cores or GPUs) based on the applied embedding profile. In some examples, data intelligence engine 120 may access these or other additional system resources (e.g., processor, memory/buffers, I/O, etc.) to generate the accurate embedding compared to those accessed during the generation of the approximate embedding.

The approximate embedding may be dynamically selected when the current system resource utilization exceeds a resource utilization threshold, so that the embedding process does not interfere with other processes. When the system resource utilization falls below the resource utilization threshold, the current system may switch to a second embedding profile (e.g., the accurate embedding process) that generates a more accurate embedding of the data object and uses the system resources that are now available for generating the embedding.

The accurate embedding may be dynamically selected when the current system resource utilization does not exceed the resource utilization threshold. In this example, embedding computing component 124 may assume that the system resources are available to implement the embedding process. When the system resource utilization exceeds the resource utilization threshold, the current system may switch to a second embedding profile (e.g., the approximate embedding process) that generates an approximate embedding of the data object and delays the use of some of the system resources as they perform other processing (e.g., other than generating an embedding using the AI model associated with the approximate embedding profile).

Embedding computing component 124 may also be configured to store the embeddings in vector data store 128 or other data storage format (e.g., a milvus vector database). Vector data store 128 can refer to a database or repository that facilitates the storage and searching of unstructured data by embedding the unstructured data (converting unstructured data into a numerical array that expresses the data's original meaning) and storing the resulting embedding vectors (unique fingerprints/values for a piece of data). Vector data store 128 may be a cloud-based database, included as part of data intelligence engine 120. Vector data store 128 may store embeddings that encode relevant data as embedding vectors.

Workload optimizer engine 126 may be configured to monitor the system utilization metrics such as CPU, memory, and I/O in an iterative process. When the system utilization falls below the resource utilization threshold or other configurable values, workload optimizer engine 126 may dynamically change the embedding profile from generating an approximate embeddings to generating an accurate embedding and initiate the generation of a new embedding (via embedding computing component 124).

Search component 140 is configured to generate an embedding of the query/prompt. In some examples, both an approximate embedding (as defined by the approximate embedding profile) and an accurate embedding (as defined by the approximate embedding profile) may be generated. Both embedding types may be generated irrespective of the current embedding profile.

Search component 140 is also configured to receive a query/prompt from an end user device (not shown). In some examples, the query can be received via an interface to search component 140 (e.g., LLM or corresponding RAG agent). Search component 140 may be trained to initiate various processes, including finding relevant documents with information that the AI model uses to generate a response. In some examples, search component 140 may implement the LLM or corresponding RAG agent without diverting from the essence of the disclosure.

Search component 140 can determine one or more embeddings that are within a latent space proximity to a semantically similar value of the query/prompt. In some examples, the embedding associated with the query/prompt may be compared to a stored embedding to determine a semantically similar value. For example, search component 140 can receive an embedding from vector data store 128 or directly from data intelligence engine 120 and use the embedding for searching workload computing component 130 (e.g., to retrieve the associated data). When the accurate embedding is available, the accurate embedding may be used to enable the search for data, otherwise the approximate embedding may be used. The embeddings may be retrieved if the embedding is relevant (e.g., within a latent space) to a response of the query/prompt.

In some examples, search component 140 may be configured to execute an information retrieval algorithm that compares numerical representations of each of the search query and the embedding, and retrieves the data that is probabilistically similar to the embedding representation of the query. In examples, search component 140 may execute cosine similarity to compute a similarity score between the numerical representation of the query and numerical representations of the embedding. The numerical representations of the embeddings can be sorted according to similarity score (e.g., highest similarity to lowest) and the most similar may be identified as probabilistically relevant to the search query. In some examples, the embedding is converted back into a text/image document that can be processed by search component 140 and generates an output that is responsive to the query.

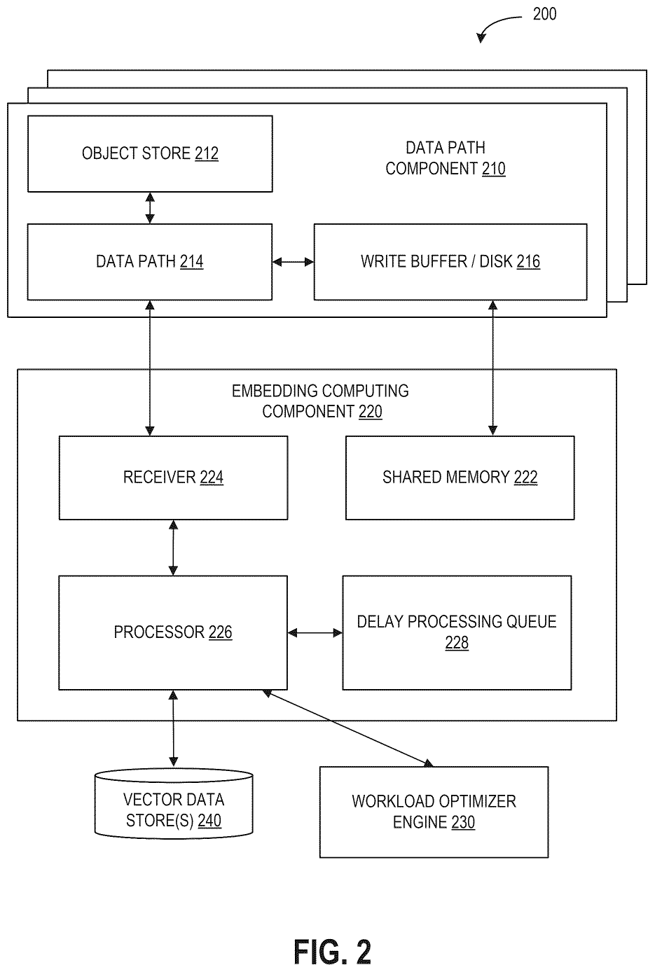

FIG. 2 illustrates a data intelligence engine 200 in which examples of the disclosed technology may be implemented. Data intelligence engine 200 may comprise data path component 210, embedding computing component 220, workload optimizer engine 230, and vector data store 240 of FIG. 2 may be an example representative of data intelligence engine 120, data path component 122, embedding computing component 124, and workload optimizer engine 126 in FIG. 1, respectively with additional detail on the interactions and features of each component provided herein.

Data path component 210 may be configured to receive a data object and store the data object at object store 212. The data object may comprise structured or unstructured information (e.g., text, image, audio, video, etc.). Data path component 210 may provide the data object to embedding computing component 220 for additional processing.

In some examples, data path component 210 is configured to expose protocol endpoints, like Amazon® s3 and NFS, to receive data. In response to exposing the endpoints, data path component 210 may receive the data through a protocol APIs, such as OBJECT PUT or FILESYSTEM WRITE.

For the data object that is received by data path component 210, data path component 210 may notify receiver 224 of embedding computing component 220 of the data object received. Receiver 224 can add the data object to its internal persistent queue (e.g., a receiver queue). Based on the availability of free segments in shared memory 222, receiver 224 may request the data with the memory location (e.g., in object store 212).

In some examples, data path component 210 can transfer the data from write buffer 216 (or from the disk) to shared memory 222. If free memory is not available, the data object may be requested at a future point in time when the memory slot is available.

Upon receiving the data, receiver 224 can notify processor 226 that the new data object has been received and may be stored in the receiver queue. Processor 226 can calculate the embedding using the determined embedding profile at that point of time. If the embedding profile is set as an approximate embedding, the data object may be added to a delay processing queue 228 maintained by processor 226. In this example, the data object may be stored in the receiver queue until it is serviced, and the data object may be stored in the delay processing queue during the delay. The data objects may be stored in the receiver queue and the delay processing queue simultaneously. In some examples, the embeddings can be stored in vector data store 240 in the appropriate collection associated with the bucket or namespace. In some examples, the approximate and accurate embeddings can be stored in separate collections, buckets, or namespaces with a link to each type of embedding. The link may correspond to an identifier or location of the embedding that is stored in the vector data store 240, delay processing queue 228, or the receiver queue.

In some examples, the links associated with the embeddings may be stored with the data object as well. For example, the data object may be associated with an accurate embedding that is accessible via a first link/identifier and also may be associated with an approximate embedding that is accessible via a second link/identifier. Both links/identifiers identifying the corresponding embeddings of the data object may be stored with the data object.

In some examples, processor 226 may identify an object identifier (ID) from the delay processing queue 228 and check shared memory 222 for the availability of the data. If the data is not available, processor 226 can transmit a request to data path 214 for the object ID of the data object in object store 212. Once the data has been transferred to the shared memory 222, processor 226 can generate the embeddings using the appropriate embedding model/profile for the accurate embedding.

In some examples, processor 226 may access one or more embedding profiles that each execute embedding processes (e.g., using different AI models) to generate different accuracy levels of embeddings. For example, a first embedding profile may be associated with a first embedding process that generates an “approximate embedding” of a data object, and a second embedding profile may be associated with a second embedding process that generates an “accurate embedding” of the data object.

The embedding profile may define rules for initiating the embedding process to generate the embeddings. The embedding may convert the data object into an embedding that represents the data object as points in a high-dimensional vector space. In some examples, the embedding may be generated using an imported library of rules that identifies the semantic relationships between words (e.g., Word2Vec, GloVe). The embedding may be a programmatic conversion of the data object into a numerical array that expresses the data's original meaning.

Workload optimizer engine 230 may be configured to determine a system resource utilization value of a system resource at a remote computing component (e.g., workload computing component). The system resource utilization value may identify an amount of a system resource that is utilized. This may include an amount of memory that is utilized, the CPU or GPU consumption value, or utilization value for other resources in the system. The system resource utilization value may be determined in association with the system resource (e.g., throughput, storage used/remaining). Multiple utilization values may be determined, including a first and second system resource utilization value.

Workload optimizer engine 230 may also be configured to monitor the system utilization metrics such as CPU, memory, and I/O in an iterative process. When the system utilization falls below the resource utilization threshold or other configurable values, workload optimizer engine 230 may dynamically change the embedding profile from generating an approximate embedding to generating an accurate embedding and initiate the generation of a new embedding (via processor 226).

During the monitoring process, workload optimizer engine 230 may assign processor 226 to a different embedding profile. For example, in the accurate embedding mode, processor 226 may aggressively service both the receiver queue at receiver 224 and delay processing queue 228 simultaneously. The aggressive servicing of both components may help clear the backlog of any remaining procedures. Workload optimizer engine 230 may continue to monitor the resource consumption of processor 226 and also monitor the total resource consumption of the system in executing services and other functionality (e.g., outside of the embedding process). If the resource consumption exceeds a first/high watermark threshold value, processor 226 may be switched back to the approximate embedding mode.

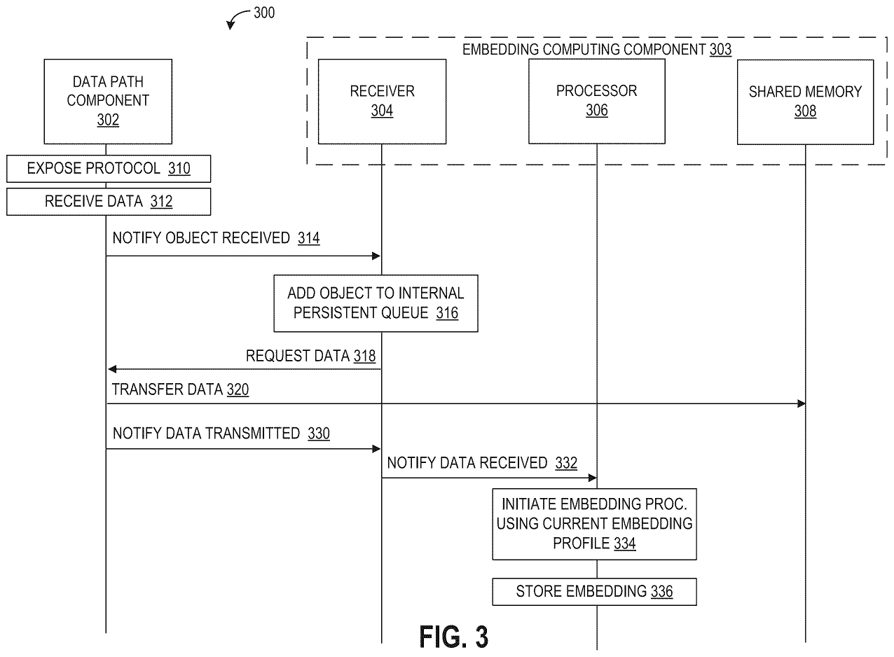

FIG. 3 is an example message flow 300 between the data path component and the embedding computing component, in accordance with some examples of the disclosed technology. In this example, components of embedding computing component 303 may communicate with various components of data path component 302, including receiver 304, processor 306, and shared memory 308.

At operation 310, data path component 302 may expose the protocol endpoints to embedding computing component 303. The protocol endpoints may include, for example, s3 and NFS, so that data path component 302 can receive the data through protocol APIs (e.g., OBJECT PUT or FILESYSTEM WRITE).

At operation 312, data path component 302 may receive data (e.g., via the API).

At operation 314, data path component 302 may notify receiver 304 of embedding computing component 303 that the data object has been received. For example, for each data object that is received by the data path component 302, receiver 304 may receive a transmitted notification that the data object was received.

At operation 316, receiver 304 of embedding computing component 303 may add the object to an internal persistent queue of embedding computing component 303.

At operation 318, receiver 304 of embedding computing component 303 may request data from data path component 302. In some examples, receiver 304 may identify whether segments in shared memory 308 are available. Based on the availability of the free segments, receiver 304 may request the data with the memory location. If free memory is not available, the data object may be requested by receiver 304 for a future point in time when a memory slot is available.

At operation 320, data path component 302 may transfer the data to shared memory 308 of embedding computing component 303. In some examples, data path component 302 may transfer the data from its internal data store (e.g., from a write buffer or from the disk) to shared memory 308.

At operation 330, data path component 302 may notify receiver 304 of embedding computing component 303 that data has been transmitted to shared memory 308.

At operation 332, receiver 304 of embedding computing component 303 may notify processor 306 of embedding computing component 303 that data has been received/stored by shared memory 308.

At operation 334, processor 306 of embedding computing component 303 may initiate an embedding process of the new data using the current embedding profile. For example, processor 306 can initiate the embedding process using the embedding profile that is currently set at that point of time.

In some examples, if the embedding profile is set as an approximate embedding, the data object can also be added to a persisted delayed queue maintained by the processor. The embeddings can be stored in a vector data store in the appropriate collection associated with the bucket or namespace, with the approximate and accurate embeddings being stored in separate collections.

At operation 336, processor 306 of embedding computing component 303 may store the embedding in a vector data store.

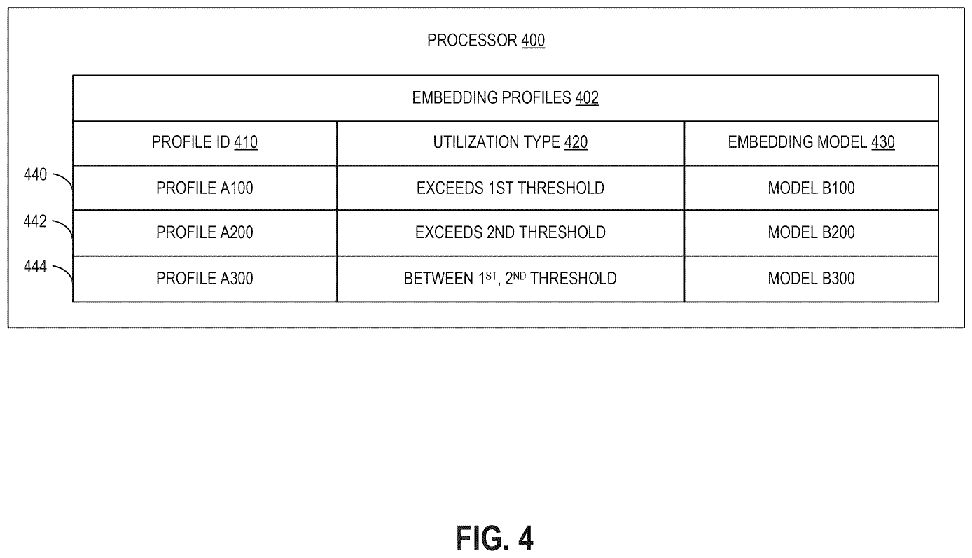

FIG. 4 illustrates an embedding profile data structure, in accordance with some examples of the disclosed technology. In some examples, processor 400 of embedding computing component may store multiple embedding profiles 402 that may be applied during a dynamic embedding process. The embedding profiles may be accessible via a link or profile ID 410. In some examples, the profile ID 410 may uniquely identify an embedding profile in the system that is accessible by the embedding computing component. The profile ID 410 may be utilized by the embedding component to search for the embedding profile in the vector data stores.

The embedding profile may also define a system resource utilization type 420. The system resource utilization type 420 may define the maximum permissible system resource utilization value of a component in the system or the entire system overall (e.g., including the data path) at which point interventions can be taken.

In some examples, embedding profiles 402 may also define the maximum permissible system resource utilization values. For example, using the defined maximum value, the embedding process can be adapted so as to compute the embedding at a capacity less than or equal to the maximum system resource utilization value defined in the profile. The system resource utilization may be limited for generating the embedding as it processes services/functions from the data intelligence engine along with other services/functions across the distributed system. The maximum permissible system resource utilization value under each profile may correspond to various system resources, including memory, number of threads, percentage of CPU or GPU utilization, and other features of the system.

The embedding profile may also define an embedding model 430. The embedding model may correspond to a particular embedding model that is used in generating the embedding under the embedding profile.

At block 440, a first embedding profile is provided with a profile ID 410 (e.g., “profile A100”), utilization type 420 (e.g., “exceeds first threshold”), and embedding model 430 (e.g., “model B100”). For example, the embedding computing component may access the embedding profile corresponding to the profile ID in the vector data stores to determine the embedding model to use. The embedding computing component may adjust the embedding process in accordance with the utilization type defined in the profile (e.g., permitting generation of the embedding with the system resource utilization value exceeding a first threshold).

At block 442, a second embedding profile is provided with a profile ID 410 (e.g., “profile A200”), utilization type 420 (e.g., “exceeds second threshold”), and embedding model 430 (e.g., “model B200”).

At block 444, a third embedding profile is provided with a profile ID 410 (e.g., “profile A300”), utilization type 420 (e.g., “between first and second threshold”), and embedding model 430 (e.g., “model B300”).

In some examples, the embedding profiles can include different configurations of thresholds or watermarks (used interchangeably) to define the embedding process for the particular embedding profile. Various thresholds or watermarks may be defined. For example, the embedding profile may define a low watermark corresponding to a minimum embedding throughput, a low watermark corresponding to a maximum CPU utilization, a low watermark corresponding to a maximum GPU utilization, a low watermark corresponding to a maximum memory utilization, a high watermark corresponding to idle time, a high watermark corresponding to a minimum embedding throughput, a high watermark corresponding with a maximum CPU utilization, a high watermark corresponding to a maximum GPU utilization, a high watermark corresponding to a maximum memory utilization, and so on.

In some examples, an approximate embedding profile may correspond to a low CPU/GPU utilization and high embedding throughput, while an accurate embedding profile may correspond to a high CPU/GPU utilization and low embedding throughput. Each of these embedding profiles may correspond to an identifier that identifies the location of the data object and embedding in an object data store.

In some examples, the configurable resource utilization threshold may help dictate the resource utilization of various components, including the embedding computing component and the data path component. For example, the configurable settings of processors may define a number of threads, a number of concurrent tasks, a maximum/minimum size of internal memory buffers, a number of assigned CPU/GPU for utilization, and so on.

In some examples, the accurate embedding model and the approximate embedding model can be different portions of the same model (e.g., 2d-matryoshka). For example, the approximate embedding model may contain the first few initial layers of the embedding model and the accurate embedding model may contain the full set of layers of the same embedding model.

In some examples, the accurate embedding model and the approximate embedding model can be different models that can be defined by different parameters, sizes, dimensions, and other features of the embedding model. As an illustrative example, the approximate embedding model may comprise 35 million parameters, 0.1 GB memory, and 512 dimensions and the accurate embedding model may comprise 7,000 million parameters, 261.49 GB memory, and 4096 dimensions.

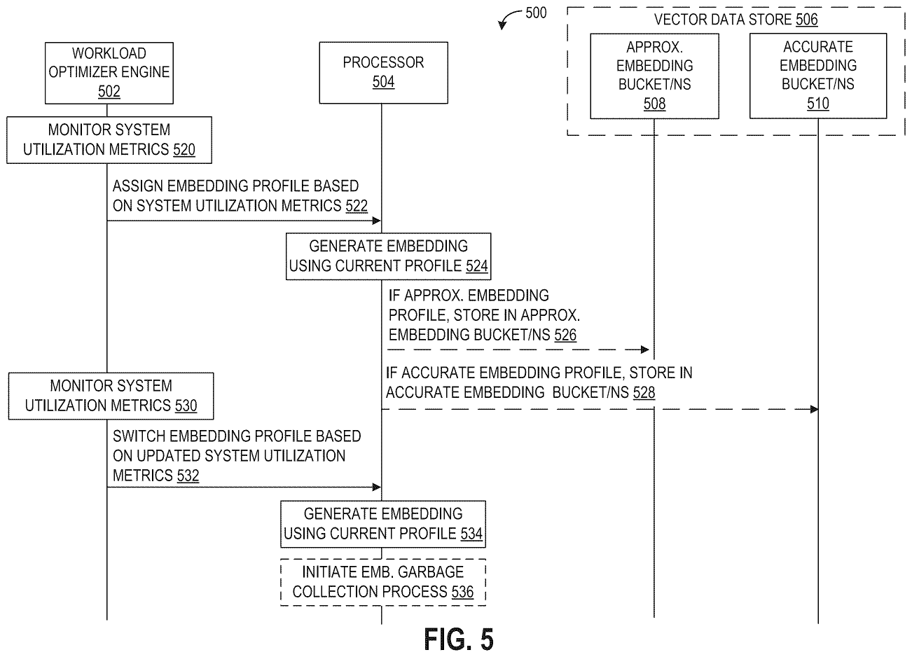

FIG. 5 is an example message flow 500 between workload optimizer engine 502, processor 504 of the embedding computing component, and vector data store 506, in accordance with some examples of the disclosed technology. In vector data store 506, multiple buckets, namespaces, or collections may be maintained for different embedding models, including an approximate embedding bucket/namespace 508 and an accurate embedding bucket/namespace 510.

At operation 520, workload optimizer engine 502 can monitor system utilization metrics. The process of monitoring the system utilization metrics may be iterative and repeatable in accordance with a determined frequency. For example, workload optimizer engine 502 may monitor for the system utilization metrics such as CPU, memory, and I/O.

At operation 522, workload optimizer engine 502 may assign an embedding profile to processor 504. The assignment of the embedding profile may be based on the system resource utilization metrics that were identified by workload optimizer engine 502.

For example, when the system resource utilization value falls below the resource utilization threshold or other configurable value, workload optimizer engine 502 can dynamically change the embedding profile from generating an approximate embeddings to generating an accurate embedding. In the accurate embedding mode, processor 504 may aggressively service both the receiver queue and the delay processing queue simultaneously and clear backlogs of processing commands (read/write). Workload optimizer engine 502 may continue to monitor the total resource consumption of the system and the resource consumption of the processor. If the resource consumption exceeds a high watermark threshold value, workload optimizer engine 502 may assign processor 504 to switch back to the approximate mode.

At operation 524, processor 504 may generate an embedding of the data object using the identified embedding profile. For example, if the embedding profile corresponds to the approximate embedding profile, processor 504 may generate an approximate embedding and if the embedding profile corresponds to the accurate embedding profile, processor 504 may generate an accurate embedding.

At operation 526, if the embedding profile corresponds to the approximate embedding profile, processor 504 may store the approximate embedding in the approximate embedding bucket/namespace 508 of vector data store 506.

At operation 528, if the embedding profile corresponds to the accurate embedding profile, processor 504 may store the accurate embedding in the accurate embedding bucket/namespace 510 of vector data store 506.

At operation 530, workload optimizer engine 502 can continue to monitor system utilization metrics. The process of monitoring the system utilization metrics may continue to be performed in an iterative manner that is repeatable in accordance with a determined frequency.

At operation 532, the system utilization metrics may be adjusted and compared to a threshold value in the embedding profile. Based on the comparison of the system utilization metrics to the threshold value, workload optimizer engine 502 may switch/assign an embedding profile to processor 504. The embedding profile may be selected based on the updated system utilization metrics.

At operation 534, processor 504 may generate an embedding of the data object using the identified embedding profile. For example, if the embedding profile corresponds to the approximate embedding profile, processor 504 may generate an approximate embedding and if the embedding profile corresponds to the accurate embedding profile, processor 504 may generate an accurate embedding.

At operation 536, processor 504 may initiate an embedding garbage collection process. For example, if system storage space is below a threshold, the garbage collector can reclaim the space by deleting the approximate embeddings of objects whose accurate embeddings have already been created. In some examples, the space may be reclaimed only if the accurate embedding profile is present.

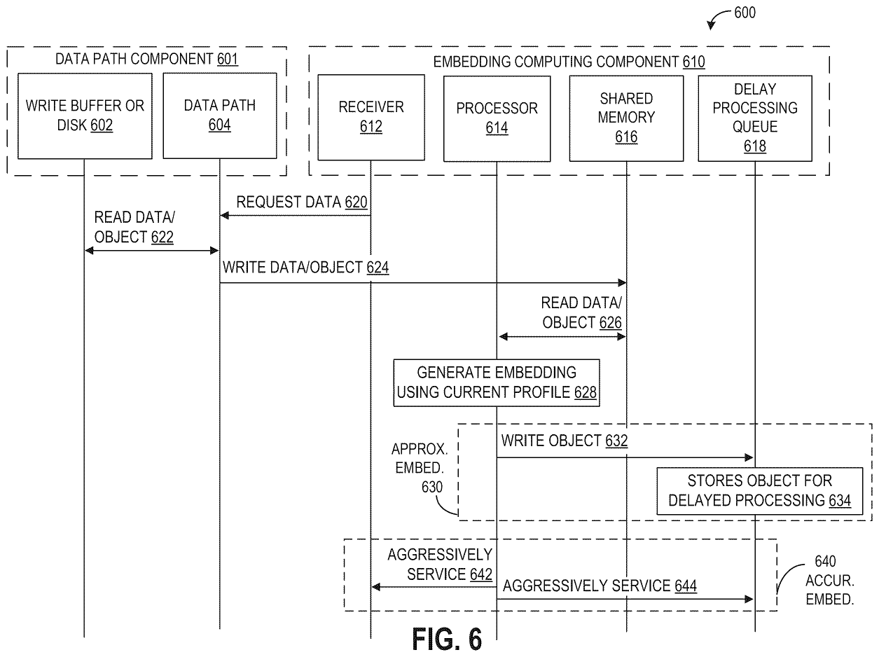

FIG. 6 is an example message flow 600 between data path component 601 and embedding computing component 610, in accordance with some examples of the disclosed technology. In data path component 601, various components may be in communication with each other, including write buffer or disk 602 and data path 604. In embedding computing component 610, various additional components may be in communication with each other, including receiver 612, processor 614, shared memory 616, and delay processing queue 618.

At operation 620, receiver 612 may request data from data path 604. For example, receiver 612 may identify whether segments in the shared memory are available. Based on the availability of the free segments, receiver 612 may request the data with the memory location. If free memory is not available, the data object may be requested by receiver 612 for a future point in time when a memory slot is available.

At operation 622, data path 604 may read the data object that has been previously stored in write buffer or disk 602.

At operation 624, data path 604 may write the data object to shared memory 616 of embedding computing component 610. For example, data path 604 can transfer the data from the write buffer or from the disk to shared memory 616. If free memory is not available, the data object may be requested at a future point in time when the memory slot is available.

At operation 626, processor 614 may read the data object that has been previously stored in shared memory 616. For example, upon receiving the data, receiver can notify processor 614 that the new data object has been received.

At operation 628, processor 614 may generate an embedding of the data object using the current embedding profile. For example, processor 614 can generate the embedding using the determined embedding profile at that point of time. If the embedding profile is set as an approximate embedding, the data object may be added to a delay processing queue maintained by processor 614.

At operation 630, a series of operations may be initiated when the embedding profile is an approximate embedding profile. For example, in response to generating the approximate embedding corresponding to the approximate embedding profile, processor 614 may write the data object to a delay processing queue 618 of embedding computing component 610 (operation 632) so that delay processing queue 618 can store the embedding for processing at a later time (operation 634).

At operation 640, a series of operations may be initiated when the embedding profile is an accurate embedding profile. For example, in response to generating the accurate embedding corresponding to the accurate embedding profile, processor 614 may aggressively service the receiver 612 (operation 642) and simultaneously aggressively service the delay processing queue 618 (operation 644). In this example, the servicing of both receiver 612 and delay processing queue 618 may increase the efficiency of processing/execution by processor 614 (e.g., while the system resource utilization value is below a threshold value).

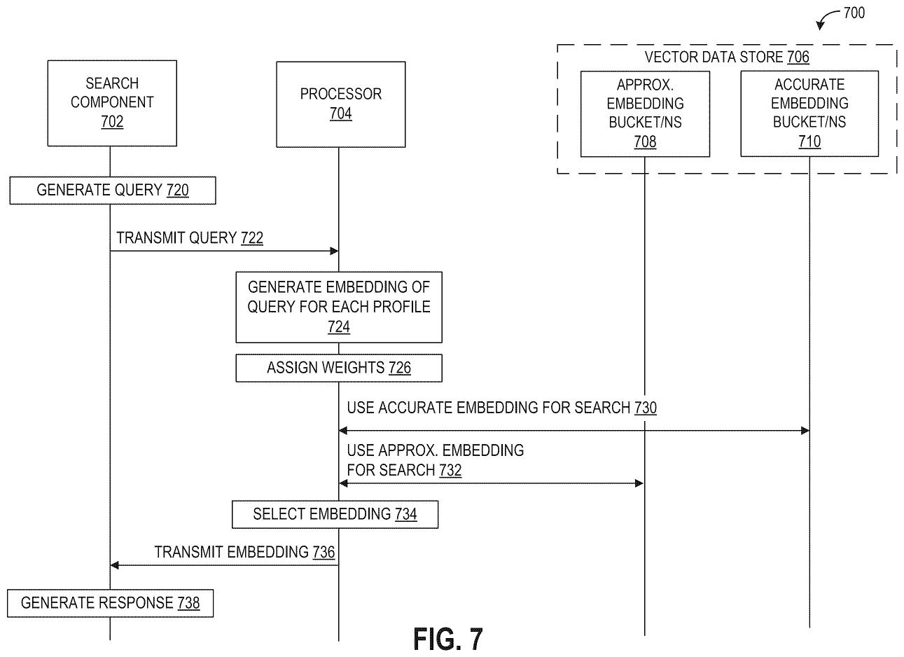

FIG. 7 is an example message flow 700 between search component 702, processor 704 of the embedding computing component, and vector data store 706, in accordance with some examples of the disclosed technology. In vector data store 706, multiple buckets, namespaces, or collections may be maintained for different embedding models, including an approximate embedding bucket/namespace 708 and an accurate embedding bucket/namespace 710.

At operation 720, search component 702 may generate a query or receive a query/prompt from an end user device. In some examples, the query can be received via an interface to search component 702 (e.g., LLM or corresponding RAG agent). The search component may be trained to initiate various processes, including finding relevant documents with information that the model uses to generate a response. Search component 702 can determine one or more embeddings that are within a latent space proximity to a semantically similar value of the query/prompt. In some examples, the embedding associated with the query/prompt may be compared to a stored embedding to determine a semantically similar value. The embeddings may be retrieved if the embedding is relevant (e.g., within a latent space) to a response of the query/prompt.

In some examples, search component 702 may be configured to execute an information retrieval algorithm that compares numerical representations of each the search query and the embedding, and retrieve the data that are probabilistically similar to the embedding representation of the query. In examples, search component 702 may execute cosine similarity to compute a similarity score between the numerical representation of the query and numerical representations of the embedding. The numerical representations of the embeddings can be sorted according to similarity score (e.g., highest similarity to lowest) and the most similar may be identified as probabilistically relevant to the search query. In some examples, the embedding is used to get the text/image associated with it that can be used to generate the answer. The corresponding data can be retrieved (e.g., text/image document) and processed by search component 702 to generate an output that is responsive to the query.

At operation 722, search component 702 may transmit the query to processor 704 of the embedding computing component. The embedding computing component can convert the query to an embedding using the embedding profile. A single query may be converted to one or more embeddings (approximate embedding and accurate embedding) and may be compared to the embeddings in the vector data store (approximate embedding and accurate embedding).

At operation 724, processor 704 of the embedding computing component can generate an embedding of the query for each available embedding profile. For example, the query may be embedded using an embedding process to generate both an accurate embedding of the query and an approximate embedding of the query.

At operation 726, processor 704 may assign weights to the embeddings. For example, processor 704 may assign a first weight to the accurate embedding of the query that is greater than a second weight that is assigned to the approximate embedding of the query.

At operation 730, processor 704 may use the accurate embedding of the query for searching the accurate embedding bucket/namespace 710 of vector data store 706.

At operation 732, processor 704 may use the approximate embedding of the query for searching the approximate embedding bucket/namespace 708 of vector data store 706.

At operation 734, processor 704 may select an embedding. For example, the selected embedding may correspond to the accurate embedding retrieved from accurate embedding bucket/namespace 710 or the approximate embedding retrieved from approximate embedding bucket/namespace 708.

At operation 736, processor 704 may transmit the selected embedding and its associated text back to search component 702.

At operation 738, search component 702 may generate a response to the query using the transmitted embedding.

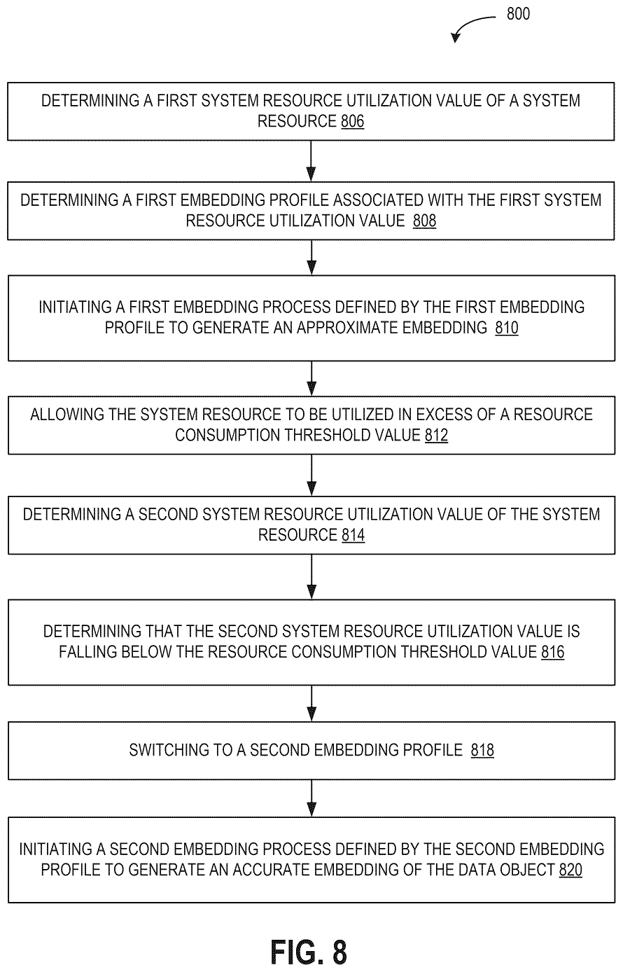

FIG. 8 is an example method 800 for implementing a dynamic embedding process based on system resource utilization, in accordance with examples of the disclosed technology. In some examples, a data intelligence engine can execute machine readable instructions to perform these and other operations described throughout the disclosure.

At operation 806, the process may determine a first system resource utilization value of a system resource. The system resource utilization value may include an amount of memory that is utilized, the CPU or GPU consumption value, or utilization value for other resources in workload computing component that are being utilized for performing a particular task or a set of processes using a system resource. In some examples, the system resource utilization value may be determined in association with a particular component of a workload computing component and an amount with which the component is being utilized (e.g., throughput, storage used/remaining).

At operation 808, the process may determine a first embedding profile associated with the first system resource utilization value. For example, a first embedding profile (e.g., an approximate embedding profile) may be associated with a first AI model that generates an approximate embedding of a data object, and a second embedding profile (e.g., an accurate embedding profile) may be associated with a second AI model that generates an accurate embedding of the data object. When comparing the two embeddings, the approximate embedding may use fewer system resources to generate the embedding than the accurate embedding process, which can create an embedding that is smaller in size, having a lower accuracy level than the accurate embedding. The use of fewer system resources can allow the workload computing component and the data intelligence engine to perform other operations, for example, I/O procedures, memory utilization, and processing functions, while still creating an embedding, without waiting for the resources to become available for creating the embedding.

In some examples, the approximate embedding profile may be dynamically selected when a current system resource utilization value of the workload computing component exceeds a resource utilization threshold, so that the embedding process executed in accordance with the approximate embedding profile does not interfere and limit the use of other system resources while the system resources are executing instructions unrelated to the embedding process. When the current system resource utilization value falls below the resource utilization threshold, the processor of the data intelligence engine may switch to a second embedding process/profile to generate a more accurate embedding. This may correspond to a two-pass embedding approach, where the first pass is to generate the approximate embedding (e.g., using a low CPU/GPU utilization and high throughput) and the second pass is to generate the accurate embedding (e.g., using a high CPU/GPU utilization and low throughput).

At operation 810, the process may initiate a first embedding process defined by the first embedding profile to generate an approximate embedding. For example, the workload optimizer engine can identify which embedding profile to use in generating the embedding of the data object. When an embedding profile is assigned to a processor of the data intelligence engine, internal resources may also be assigned to execute the embedding process. The embedding process may utilize a maximum of an in-memory queue limit, concurrent processing task limit, memory buffers, processors (e.g., CPU cores or GPUs), or other system components based on the applied embedding profile.

At operation 812, the process may allow the system resource to be utilized in excess of a resource consumption threshold value. For example, when a current system resource utilization value of the workload computing component exceeds a resource utilization threshold, the embedding process executed in accordance with the approximate embedding profile may not interfere and limit the use of other system resources while the system resources are executing instructions unrelated to the embedding process. In some examples, when the current system resource utilization value falls below the resource utilization threshold, the process may switch to a second embedding process/profile to generate a more accurate embedding.

At operation 814, the process may determine a second system resource utilization value of the system resource. In some examples, the second system resource utilization value may be the same type of resource utilization value as the first system resource utilization value. As such, the second system resource utilization value can include an amount of memory that is utilized, the CPU or GPU consumption value, or utilization value for other resources in workload computing component that are being utilized for performing a particular task or a set of processes using a system resource.

At operation 816, the process may determine that the second system resource utilization value is falling below the resource consumption threshold value. For example, the process may determine the system resource utilization value and compare it with the resource utilization threshold to identify that the resource utilization has fallen with respect to the earlier determination.

At operation 818, the process may switch to a second embedding profile. For example, the process can dynamically switch between the two embedding profiles. The data intelligence engine can comprise a workload optimizer engine to initiate the switching between the two embedding profiles and a processor to execute the embedding process. For example, in response to the second system resource utilization value falling below the resource utilization threshold, the process may switch to a second embedding profile that generates an accurate embedding of the data object with increased use of the system resource compared to the first embedding profile.

In some examples, the embedding process may correspond to a two-pass embedding approach, utilized by the switch from the first embedding profile to the second embedding profile. The first pass may be to generate the approximate embedding (e.g., using a low CPU/GPU utilization and high throughput) and the second pass may be to generate the accurate embedding (e.g., using a high CPU/GPU utilization and low throughput). Generating embeddings in accordance with the accurate embedding profile may generate an embedding with a larger file size than that generated in accordance with the approximate embedding profile, using system resources that were previously unavailable or limited for generating the embedding.

At operation 820, the process may initiate a second embedding process defined by the second embedding profile to generate an accurate embedding of the data object. For example, the workload optimizer engine can identify which embedding profile to use in generating the embedding of the data object. When an embedding profile is assigned to a processor of the data intelligence engine, internal resources may also be assigned to execute the embedding process. The embedding process may utilize a maximum of an in-memory queue limit, concurrent processing task limit, memory buffers, processors (e.g., CPU cores or GPUs), or other system components based on the applied embedding profile.

In some examples, generating embeddings in accordance with the accurate embedding profile may generate an embedding with a larger file size than that generated in accordance with the approximate embedding profile, using system resources that were previously unavailable or limited for generating the embedding.

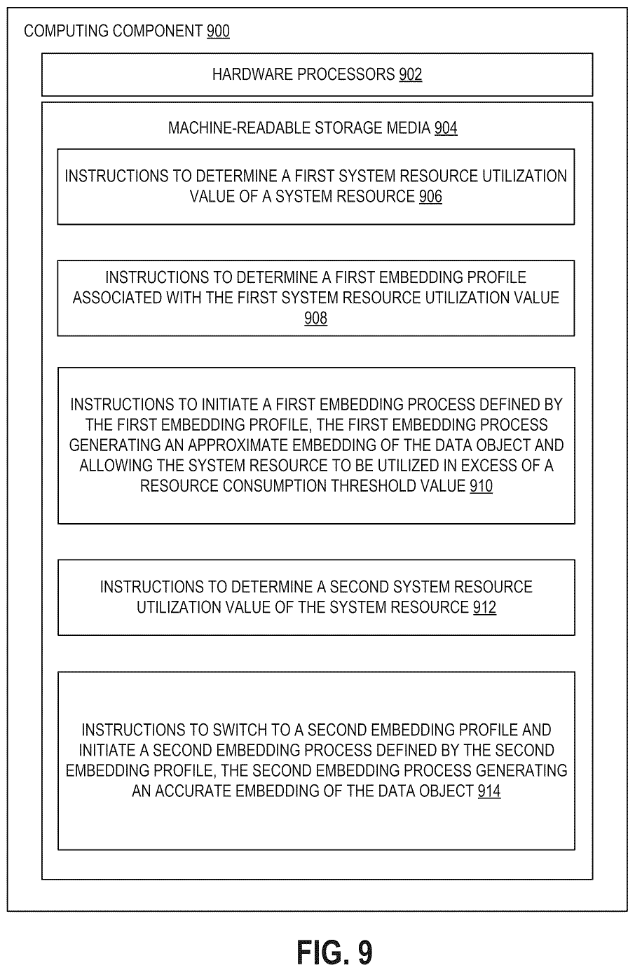

FIG. 9 illustrates a computing component that may be used to implement dynamic embedding process based on system resource utilization in accordance with various examples of the disclosed technology. Referring now to FIG. 9, computing component 900 may be, for example, a server computer, a controller, or any other similar computing component capable of processing data. In the example implementation of FIG. 9, computing component 900 includes a hardware processor 902 and machine-readable storage medium 904.

Hardware processor 902 may be one or more central processing units (CPUs), semiconductor-based microprocessors, and/or other hardware devices suitable for retrieval and execution of instructions stored in machine-readable storage medium 904. Hardware processor 902 may fetch, decode, and execute instructions, such as instructions 906-914, to control processes or operations for burst preloading for available bandwidth estimation. As an alternative or in addition to retrieving and executing instructions, hardware processor 902 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 904, may be any electronic, magnetic, optical, or other physical storage device that contains or stores executable instructions. Thus, machine-readable storage medium 904 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 904 may be a non-transitory storage medium, where the term “non-transitory” does not encompass transitory propagating signals. As described in detail below, machine-readable storage medium 904 may be encoded with executable instructions, for example, instructions 906-914.

Hardware processor 902 may execute instruction 906 to determine a first system resource utilization value of a system resource. Current system resource utilization may correspond to, e.g., memory utilization, CPU or GPU consumption, I/O throughput, or other operation of system measured by the workload computing component that can be utilized by a service/function call from the data intelligence engine. The first system resource utilization value may be determined in response to receiving a data object.

Hardware processor 902 may execute instruction 908 to determine a first embedding profile associated with the first system resource utilization value.

Hardware processor 902 may execute instruction 910 to initiate a first embedding process defined by the first embedding profile. In some examples, the first embedding process may generate an approximate embedding of the data object. The instruction may allow the system resource to be utilized in excess of a resource consumption threshold value.

Hardware processor 902 may execute instruction 912 to determine a second system resource utilization value of the system resource.

Hardware processor 902 may execute instruction 914 to switch to a second embedding profile. In response to switching to the second embedding profile, the instruction may initiate a second embedding process defined by the second embedding profile. The second embedding process can generate an accurate embedding of the data object.

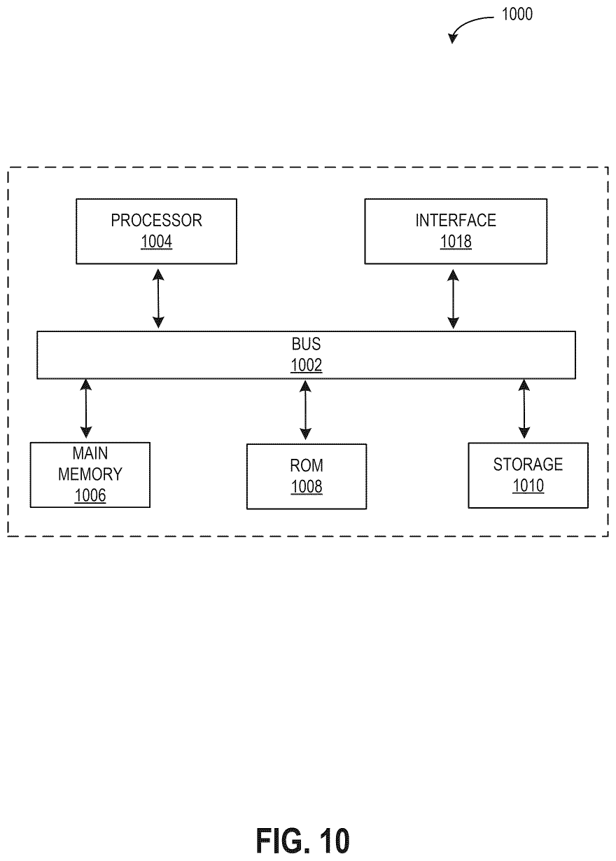

FIG. 10 depicts a block diagram of an example computer system 1000 in which various examples of the disclosed technology described herein may be implemented. The computer system 1000 includes a bus 1002 or other communication mechanism for communicating information, one or more hardware processors 1004 coupled with bus 1002 for processing information. Hardware processor(s) 1004 may be, for example, one or more general purpose microprocessors.

The computer system 1000 also includes a main memory 1006, such as a random access memory (RAM), cache and/or other dynamic storage devices, coupled to bus 1002 for storing information and instructions to be executed by processor 1004. Main memory 1006 also may be used for storing temporary variables or other intermediate information during execution of instructions to be executed by processor 1004. Such instructions, when stored in storage media accessible to processor 1004, render computer system 1000 into a special-purpose machine that is customized to perform the operations specified in the instructions.

The computer system 1000 further includes a read only memory (ROM) 1008 or other static storage device coupled to bus 1002 for storing static information and instructions for processor 1004. A storage device 1010, such as a magnetic disk, optical disk, or USB thumb drive (Flash drive), etc., is provided and coupled to bus 1002 for storing information and instructions.

The computing system 1000 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” “data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 1000 may implement the techniques described herein using customized hard-wired logic, one or more ASICs or FPGAs, firmware and/or program logic which in combination with the computer system causes or programs computer system 1000 to be a special-purpose machine. According to one example of the disclosed technology, the techniques herein are performed by computer system 1000 in response to processor(s) 1004 executing one or more sequences of one or more instructions contained in main memory 1006. Such instructions may be read into main memory 1006 from another storage medium, such as storage device 1010. Execution of the sequences of instructions contained in main memory 1006 causes processor(s) 1004 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1010. Volatile media includes dynamic memory, such as main memory 1006. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1002. Transmission media can also take the form of acoustic or light waves, such as those generated during radio-wave and infra-red data communications.

The computer system 1000 also includes interface 1018 coupled to bus 1002. Interface 1018 provides a two-way data communication coupling to one or more network links that are connected to one or more local networks. For example, interface 1018 may be an integrated services digital network (ISDN) card, cable modem, satellite modem, or a modem to provide a data communication connection to a corresponding type of telephone line. As another example, interface 1018 may be a local area network (LAN) card to provide a data communication connection to a compatible LAN (or WAN component to communicate with a WAN). Wireless links may also be implemented. In any such implementation, interface 1018 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 1018, which carry the digital data to and from computer system 1000, are example forms of transmission media.

The computer system 1000 can send messages and receive data, including program code, through the network(s), network link and interface 1018. In the Internet example, a server might transmit a requested code for an application program through the Internet, the ISP, the local network and interface 1018.

The received code may be executed by processor 1004 as it is received, and/or stored in storage device 1010, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1000.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A data intelligence engine comprising:
a memory storing instructions; and
a processor communicatively coupled to the memory and configured to execute the instructions to:
determine a first system resource utilization value of a system resource;
in response to the first system resource utilization value exceeding a resource utilization threshold, select a first embedding profile that generates an approximate embedding of a data object using the system resource that limits use of the system resource during the generation of the approximate embedding;
generate the approximate embedding according to the first embedding profile;
determine a second system resource utilization value of the system resource; and
in response to the second system resource utilization value falling below the resource utilization threshold, switch to a second embedding profile that generates an accurate embedding of the data object with increased use of the system resource compared to the first embedding profile.

2. The data intelligence engine of claim 1, wherein the system resource utilization value defines a memory utilization, Central Processing Unit (CPU) or Graphics Processing Unit (GPU) consumption, or I/O throughput of a workload computing component.

3. The data intelligence engine of claim 1, wherein the first system resource utilization value is calculated remotely from the data intelligence engine at a workload computing component, and the processor is further configured to:
prior to determining the first system resource utilization value, receive, from the workload computing component, the first system resource utilization value.

4. The data intelligence engine of claim 3, wherein the processor is further configured to:
provide, to a search component, the accurate embedding for accessing data at an object client corresponding to the data object when the accurate embedding is available, otherwise provide the approximate embedding.

5. The data intelligence engine of claim 4, wherein the search component uses a large language model (LLM), retrieval-augmented generation (RAG), or semantic search.

6. The data intelligence engine of claim 1, wherein limiting use of the system resource causes the processor to:
service a receiver queue of data objects and a delay processing queue of the data objects, simultaneously.

7. The data intelligence engine of claim 1, wherein the processor is further configured to:
initiate an embedding garbage collection process; and
in response to generating the accurate embedding, delete the approximate embedding using the embedding garbage collection process.

8. The data intelligence engine of claim 1, wherein the approximate embedding and the accurate embedding are generated using different models defined in embedding profiles, including the first embedding profile and the second embedding profile, respectively, and the approximate embedding and the accurate embedding are stored in different embedding collections in a vector data store.

9. The data intelligence engine of claim 1, wherein the processor is further configured to:
generate a first link to the approximate embedding; and
store the first link with the data object.

10. The data intelligence engine of claim 10, wherein the processor is further configured to:
generate a second link to the accurate embedding; and
store the second link with the data object.

11. The data intelligence engine of claim 1 that further comprises:
an embedding computing component; and
a workload optimizer engine,
wherein the processor is further configured to:
in response to selecting the first embedding profile or the second embedding profile, utilize the embedding computing component and the workload optimizer engine for generating the approximate embedding or the accurate embedding, respectively.

12. The data intelligence engine of claim 1 that further comprises:
a data path storage engine;
wherein the processor is further configured to:
expose protocol endpoints to receive the data object through protocol Application Programming Interfaces (APIs); and
store the accurate embedding in a first vector database collection for accurate embeddings and store the approximate embedding in a second vector database collection for approximate embeddings.

13. The data intelligence engine of claim 12 that further comprises:
a receiver;
wherein the processor is further configured to:
receive a notification that the data object is received by the data path storage engine; and
in response to the notification, based on availability of free segments in a shared memory, request the data object with a location in an internal persistent queue, and add, by the receiver, the data object to the location in the internal persistent queue.

14. A method comprising:
determining, by a data intelligence engine, a first system resource utilization value of a system resource;
in response to the first system resource utilization value exceeding a resource utilization threshold, generating an approximate embedding of a data object using a first model defined by a first embedding profile that limits use of the system resource during the generation of the approximate embedding;
generating, by the data intelligence engine, the approximate embedding according to the first embedding profile;
determining, by the data intelligence engine, a second system resource utilization value of the system resource; and
in response to the second system resource utilization value falling below the resource utilization threshold, generating an accurate embedding of the data object by a second model defined by a second embedding profile that generates the accurate embedding with increased use of the system resource compared to the first embedding profile.

15. The method of claim 14, wherein the system resource utilization value defines a memory utilization, Central Processing Unit (CPU) or Graphics Processing Unit (GPU) consumption, or I/O throughput of a workload computing component.

16. The method of claim 14, wherein the approximate embedding and the accurate embedding are generated using different embedding collections stored in a vector data store.

17. The method of claim 14, further comprising:
in response to selecting the first embedding profile or the second embedding profile, utilizing, by the data intelligence engine, an embedding computing component and a workload optimizer engine for generating the approximate embedding or the accurate embedding, respectively.

18. A non-transitory computer-readable storage medium storing a plurality of instructions executable by a processor, the plurality of instructions when executed by the processor cause the processor to:
determine a first system resource utilization value of a system resource;
in response to the first system resource utilization value is below a resource utilization threshold, select a first embedding profile that increases use of the system resource during generation of an accurate embedding when compared to a second embedding profile;
generate the accurate embedding of a data object according to the first embedding profile;
determine a second system resource utilization value of the system resource; and
in response to the second system resource utilization value exceeds the resource utilization threshold, switch to the second embedding profile that limits use of the system resource during generation of an approximate embedding of the data object.

19. The non-transitory computer-readable storage medium of claim 18, wherein limiting use of the system resource causes the processor to:
service a receiver queue of data objects and a delay processing queue of the data objects, simultaneously.

20. The non-transitory computer-readable storage medium of claim 18, wherein the processor is further caused to:
expose protocol endpoints to receive the data object through protocol Application Programming Interfaces (APIs); and
store the accurate embedding in a first vector database collection for accurate embeddings and store the approximate embedding in a second vector database collection for approximate embeddings.
